(19) United States
(12) Patent Application Publication
(10) Pub. No.: US 2002/0165826 A1
(43) Pub. Date: Nov. 7, 2002

(54) Method and system of administering user rights of a software program that can be increased in number in an emergency

(75) Inventor: Kouji Yamamoto, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/098,518

(22) Filed: Mar. 18, 2002

(30) Foreign Application Priority Data
May 7, 2001 (JP) 2001-136477

(51) Int. Cl. G06F 17/60

(52) U.S. Cl. 705/59

(57) ABSTRACT

An administrative method of user rights that can expand a volume license of a software program through a computer network and an administrative system of user rights utilizing the same. A licensee of the software program can obtain additional user rights without undertaking ordinary procedures of the licensing agreement and quickly increase the number of end-users even in an emergency such as a natural disaster.

### BACKGROUND OF THE INVENTION

1. Field of the Invention

The present invention generally relates to an administrative method and a system of user rights, and more particularly, to a method of administering an expansion of a volume license in an emergency.

2. Description of the Related Art

Many administrative methods of software user rights have been proposed and used in practice. Most of the administrative methods manage only the number of user rights that is agreed on between a licensor and a licensee such as a company. In case of an emergency such as a natural disaster, the software user purchases additional user rights if the software user wants to expand a volume license even temporarily to cope with the emergency.

A licensee such as a company has in-house rules and procedures that are applicable to any purchase of goods. The in-house rules and procedures are applied even to intangible assets including the licensing of software programs and the acquisition of user rights.

In an emergency, however, countermeasures must be taken quickly. For example, in the case of a natural disaster such as an earthquake, a construction company is required to estimate costs that are necessary to repair victims' houses and public transportation systems using cost estimation systems in a short period after the occurrence of the natural disaster. The construction company, as a software licensee, complies with the in-house rules and procedures when purchasing additional user rights of the cost estimation system.

If the software user is insured and an abnormal situation has caused any damage, an insurance company pays damages based on predetermined terms and conditions after the inspection and estimation of the damage. Many insurance agreements stipulate a down payment, payable prior to the inspection and estimation of the damage to ensure quick remedy, followed by the payment of the remainder of the insurance. The software user may spend the down payment of the insurance for the purchasing of additional user rights (expansion of the volume license).

As described above, the purchasing of additional user rights usually takes time and therefore cannot satisfy the software user's demand for an immediate expansion of the user rights.

To eliminate these problems, some administrative methods that flexibly change the number of the user rights by dividing a user right into a plurality of user rights is proposed and available as software packages in the market. The administrative methods help the software user to cope with the necessity of the expansion of volume licenses.

For example, the administrative method described in the Japanese laid-open patent application No. 10-133870 assigns a predetermined number of points to the use of each function of a licensed software program and reduces the total points that the software user has purchased by the predetermined points when the software user uses the software.

The Japanese laid-open patent application No. 2000-305775 describes a method in which an administrative center of a software administrator receives the information connected to the number of software users sent by user terminals, and charges additional licensing fees to the software user if the number of software uses exceeds a predetermined number of software uses stipulated in a volume licensing agreement.

When the number of requests for software use exceeds the predetermined number in the volume licensing agreement, the method described in the Japanese patent No. 3143648 automatically enables the users based on the volume licensing policy.

All of the above methods make the administration of the user rights easy, however, still inherit the following problems.

Since the above conventional methods divide a user right into a plurality of user rights that stay valid for a shorter time period than the original user right, the licensee still has to purchase additional user rights. The software users have consequently experienced the difficulties of controlling the budget for purchasing user rights, wanting to make the licensing agreement simple, and even eliminating the procedure of purchasing of additional user rights.

The conventional administrative methods described in the Japanese laid-open patent No. 10-133870 and No. 2000-305775, and the Japanese patent No. 3143648 do not have a mechanism that determines whether the expansion of volume licenses is necessary.

### SUMMARY OF THE INVENTION

Accordingly, it is a general object of the present invention to provide a novel and useful administrative method of user rights in which one or more of the problems described above are eliminated.

Another and more specific object of the present invention is to provide an administrative method of user rights that easily expands a volume license in an emergency.

To achieve one of the above objects, a method of administering user rights of a software program that can be increased in number, includes a step of a user rights administrative apparatus of determining whether a predetermined event has occurred, a step of the user rights administrative apparatus of informing a licensee of the occurrence of the predetermined event, a step of the licensee of acquiring expansion information that causes the user rights administrative apparatus to revise user rights information indicating the maximum number of users permitted to use the software program, a step of the licensee of providing the expansion information to the user rights administrative apparatus, and a step of the user right administrative apparatus of revising, in response to reception of the expansion information, the user right information stored therein.

The predetermined event is reception of an alarm indicating that a natural disaster has occurred, for example. Once the alarm is received, the user rights administrative apparatus informs the licensee of the reception to let the licensee acquire the expansion information that causes the user rights administrative apparatus to revise the user rights information stored therein and increase the maximum number of users who are permitted to use the software program to cope with the critical situation.

Besides the reception of the alarm, the predetermined event can be a situation in which a number indicative of how many times the licensee is not allowed to activate the software program because no user rights remain unused exceeds a predetermined number.

Other objects, features, and advantages of the present invention will be more apparent from the following detailed description when read in conjunction with the accompanying drawings.

### BRIEF DESCRIPTION OF THE DRAWINGS

FIG. 1 is a schematic drawing showing an administrative system of user rights according to the first embodiment of the present invention;

FIG. 2 is a schematic drawing showing the hardware configuration of the administrative system of user rights according to the embodiments;

FIG. 3 is a flow diagram showing user rights inquiry processing according to the first embodiment;

FIG. 4 is a flow diagram showing user rights expansion processing according to the first embodiment;

FIG. 5 is an example of a user rights information table according to the first embodiment;

FIG. 6 is a schematic drawing showing an administrative system of user rights according to the second embodiment;

FIG. 7 is a schematic drawing showing an administrative system of user rights according to the third embodiment;

FIG. 8 is a schematic drawing showing an administrative system of user rights according to the fourth embodiment;

FIG. 9 is a schematic drawing showing an administrative system of user rights according to the fifth embodiment;

FIG. 10 is a flow diagram showing user right acquisition processing according to the fifth embodiment;

FIG. 11 is an example of a user rights information table according to the fifth embodiment;

FIG. 12 is an example of an expanded user rights information table according to the fifth embodiment;

FIG. 13 is a schematic drawing showing an administrative system of user rights according to the sixth embodiment;

FIG. 14 is a schematic drawing showing an administrative system of user rights according to the seventh embodiment;

FIG. 15 is a flow diagram showing user rights inquiry processing according to the seventh embodiment;

FIG. 16 is a flow diagram showing processing in response to the occurrence of predetermined events according to the present invention;

FIG. 17 is an example of an expanded user rights information table according to the seventh embodiment;

FIG. 18 is a schematic drawing showing an administrative system of user rights according to the eighth embodiment;

FIG. 19 is a flow diagram showing user rights inquiry processing according to the eighth embodiment;

FIG. 20 is a flow diagram showing user rights number registration processing according to the eighth embodiment;

FIG. 21 is an example of a user rights number table according to the eighth embodiment; and

FIG. 22 is an example of a user rights registration table according to the eighth embodiment.

### DETAILED DESCRIPTION OF THE PREFERRED EMBODIMENTS

A description of the embodiments of the present invention will be given below by reference to the drawings.

[First Embodiment]

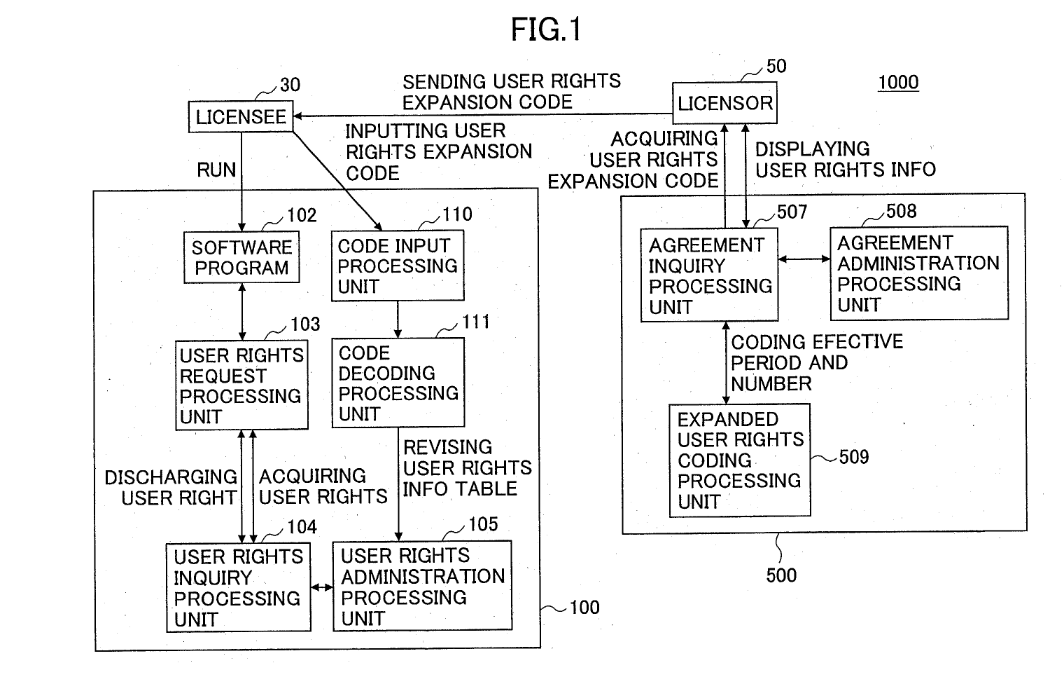

A computer system that embodies the administrative method of user rights that expands a volume license (that is, increases the number of user rights and/or extends the effective period of user rights) as the first embodiment of the present invention is shown in FIG. 1.

FIG. 1 is a schematic drawing showing the configuration of functions according to the first embodiment.

A user rights administrative system 1000 includes a software user rights administrative apparatus 100 that is operated by a licensee 30 and a software agreement administrative apparatus 500 that is operated by a licensor 50 who grants the volume license of a software program 102 to the licensee 30.

The software user rights administrative apparatus 100 includes the software program 102, a user rights request processing unit 103, a user rights inquiry processing unit 104, a user rights administration processing unit 105, a code input processing unit 110, and a code decoding processing unit 111.

In response to a request of an end-user of the licensee 30, the software program 102 activates the user rights request processing unit 103.

In response to a request for a user rights acquisition issued by the software program 102, the user rights request processing unit 103 requests the user rights inquiry processing unit 104 for the user rights acquisition or a discharge of user rights.

In response to a request of the user rights request processing unit 103, the user rights inquiry processing unit 104 verifies a user rights by searching for a user rights information table administered by the user rights administration processing unit 105.

In response to a search request from the user rights inquiry processing unit 104, the user rights administration processing unit 105 searches the user rights information table and provides the result to the user rights inquiry processing unit 104

The code input processing unit 110, in response to an identification code input by the licensee 30 to expand the volume license, provides the identification code input by the licensee 30 to the code decoding processing unit 111.

The code decoding processing unit 111 decodes the identification code provided by the code input processing unit 110 and revises the user rights information table searched by the user rights administration processing unit 105.

The software agreement administrative apparatus 500 includes an agreement inquiry processing unit 507, an agreement administration processing unit 508, and an expanded user rights coding processing unit 509.

The agreement inquiry processing unit 507 searches, in response to a user rights coding request from the licensor 50, agreement information connected to the user rights coding request in the agreement administration processing unit 508. The expanded user rights coding processing unit 509 converts the agreement information including an effective period and an expansion of user rights into an identification code.

The agreement administration processing unit 508 searches, in response to a search request from the agreement inquiry processing unit 507, the agreement information connected to the user rights coding request and provides the result of the search to the agreement inquiry processing unit 507.

The expanded user rights coding processing unit 509, in response to the coding request issued by the agreement inquiry processing unit 507, converts the agreement information into an identification code and informs the agreement inquiry processing unit 507 of the identification code.

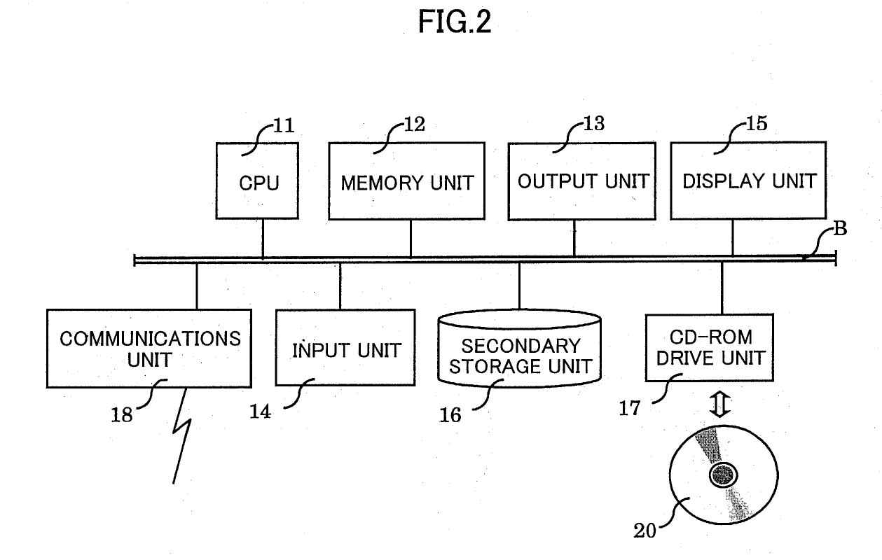

The hardware configuration of the software user rights administrative apparatus 100, a part of the user rights administration system 1000 as the first embodiment of the present invention, for example, is shown in FIG. 2.

The software user rights administrative apparatus 100 is a computer system including a central processing unit (CPU) 11, a memory unit 12, an output unit 13, an input unit 14, a display unit 15, an secondary storage unit 16, a CD-ROM drive unit 17, and a communication unit 18. These units 11, 12, 13, 14, 15, 16, 17, and 18 are all connected to a bus B.

The CPU 11 controls the software user rights administrative apparatus 100 by executing the computer program stored in the memory unit 12, and performs jobs connected to the entire user rights administrative system 1000 as described later. The memory unit 12 consists of RAMs and ROMs and stores therein the computer programs executed by the CPU 11 and data that are processed and are to be processed by the CPU 11. A portion of the memory area of the memory unit 12 is used as a working area of the CPU 11.

The output unit 13 includes a printer, for example, and outputs designated information. The input unit 14 includes a mouse and a keyboard for the user to input information necessary for the processes of the entire user rights administrative system 1000 as described later, such as registration data. The display unit 15 displays information necessary for an end-user of the licensee 30 under the control of the CPU 11.

The secondary storage unit 16 consists of a rigid disk drive, for example, and stores various files and computer programs.

The computer programs related to the processes of the user rights administrative system 1000 are initially stored in CD-ROM 20. When CD-ROM 20 is set in CD-ROM drive unit 17, the computer programs stored in CD-ROM 20 is read by CD-ROM drive unit 17 and installed in the secondary storage unit 16 via the bus B. When the user rights administrative system is activated, the computer programs stored in the secondary storage unit 16 are executed by the CPU 11. The CD-ROM 20 can be replaced with any information storage medium as long as it is computer-readable.

The hardware configuration of the software agreement administrative apparatus 500, another part of the user rights administrative system 1000 as the first embodiment of the present invention is identical to the hardware configuration of the software user rights administrative apparatus 100 shown in FIG. 2.

The user rights inquiry process performed by the software user rights administrative apparatus 100 is described next.

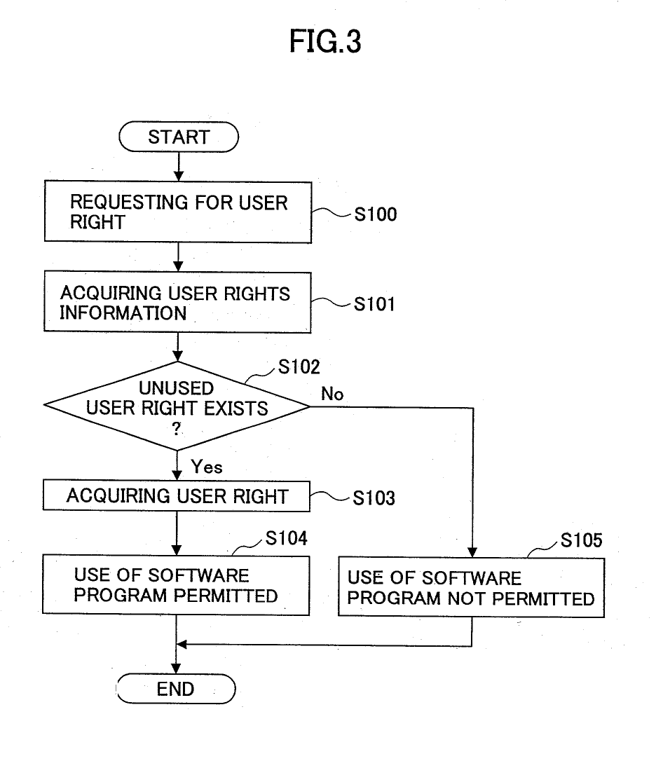

FIG. 3 is a flow diagram showing the user rights inquiry process.

When an end-user of the licensee 30 tries to run the software program 102, the software program 102 activates the user rights request processing unit 103 to request for a user rights (Step S100). The user rights inquiry processing unit 104 searches a user rights information table in the user rights administration processing unit 105 (S101), and determines whether any unused user right exists by subtracting the number of users currently using the software program 102 from the maximum number of users that can use the software program 102 at the same time as of the date of the request (S102). If any unused user right exists, a user right of the software program 102 is given to the licensee 30 (S103). The end-user of the licensee 30 can use the software program 102 (S104). Otherwise, if no unused user right exists, the end-user of the licensee 30 is not allowed to use the software program 102 (S105). The end-user of the licensee 30 cannot use the software.

A description will be given below about a user rights expansion processing in which the number of user rights is expanded when one or more predetermined events stipulated in a volume licensing agreement between the licensee 30 and the licensor 50 occurs.

The licensor 50 first requests the agreement inquiry processing unit 507 for the coding of expanded user rights. The agreement inquiry processing unit 507 searches agreement information in the agreement administration processing unit 508 and converts the agreement information into an identification code using the expanded user rights coding processing unit 509. The agreement inquiry processing unit 507 outputs the identification code to the licensor 50, and the licensor 50 transfers the identification code to the licensee 30.

A user rights expansion process of the licensee 30 will be described below

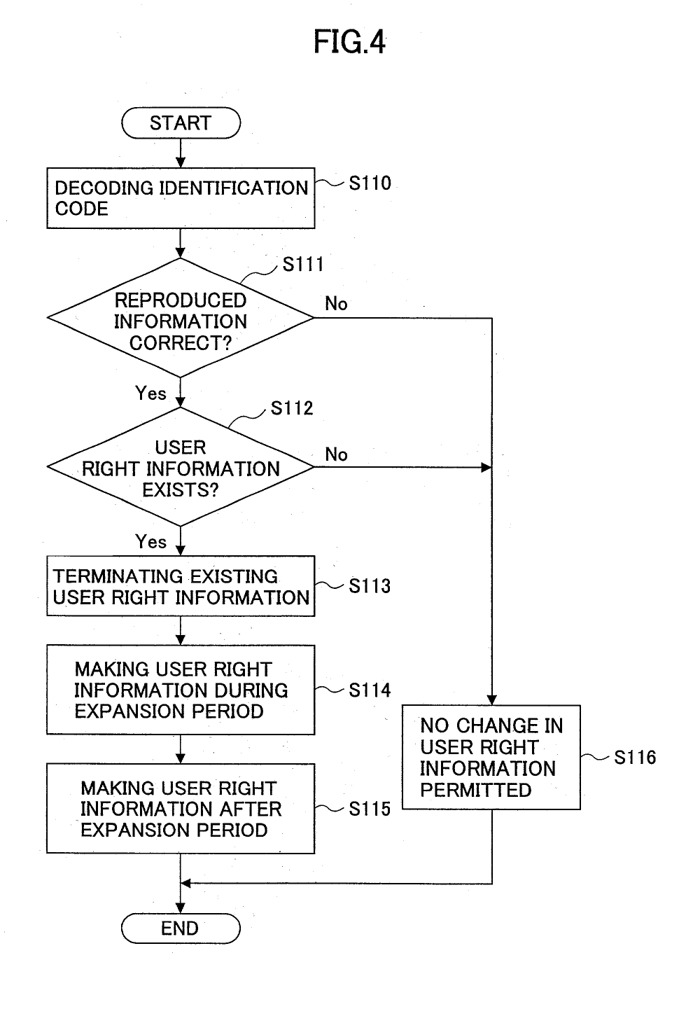

FIG. 4 is a flow diagram showing the user rights expansion process. The identification code transferred from the licensor 50 to the licensee 30 is input to the code input processing unit 110 and decoded by the code decoding processing unit 111. The software user rights administrative apparatus 100 obtains information of the software name, user rights period, and the number of user rights (S110).

The code decoding processing unit 111 determines whether the information obtained from the software agreement administrative apparatus 500 is correct (S111). If the information is not correct, the licensee 30 is not allowed to use the software 102.

If the information is correct, the code decoding processing unit 111 searches user rights information of the software 102 in the user rights administration processing unit 105 (S112). The user rights information is renewed as follows: the old user right is terminated on the day before the expansion by setting the expiration date at the day (S113); the code decoding processing unit 111 adds the user right information connected to the period of the expansion (S114); the code decoding processing unit 111 adds the user right information connected to the period after the expansion period (S115).

When the user rights request processing unit 103 is activated, the number of unused user rights is calculated based on the expanded number of user rights effective in the expansion period.

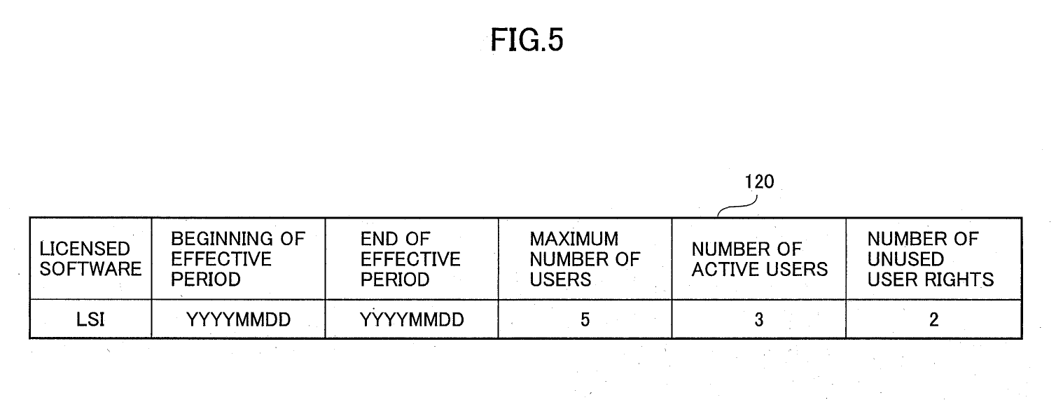

The user rights information table administered by the user rights administration processing unit 105 of the software user rights administrative apparatus 100, for example, is shown in FIG. 5.

FIG. 5 is a schematic drawing showing the user rights information table. The user rights information table 120 includes a column “Licensed Software” indicating the name of software that is licensed to the licensee 30, a column “Beginning of Effective Period”, a column “End of Effective Period”, a column “Maximum Number of Users” indicating the maximum number of users who can use the software program 102 simultaneously, a column “Number of Active Users” indicating the number of users who are currently using the software program 102, a column “Number of Unused User Rights” indicating the number of users who can use the software program 102 in addition to the number of the current users.

The user rights information table shown in FIG. 5, for example, indicates “LS1” in the “Licensed Software” column, “YYYYMMDD” (YYYY, MM, and DD indicate a year, a month, and a day, respectively) in the “Beginning of Effective Period” column and the “End of Effective Period” column, “5” in the “Maximum Number of Users” column, “3” in the “Number of Active Users” column, and “2” in the “Number of Unused User Right” column.

Since the user rights information table is structured as described above, it is easy to change the number of user rights to the original number when the effective period passes.

[Second Embodiment]

A computer system that informs the licensee 30 of any occurrence of events that is stipulated in the volume licensing agreement will be explained below.

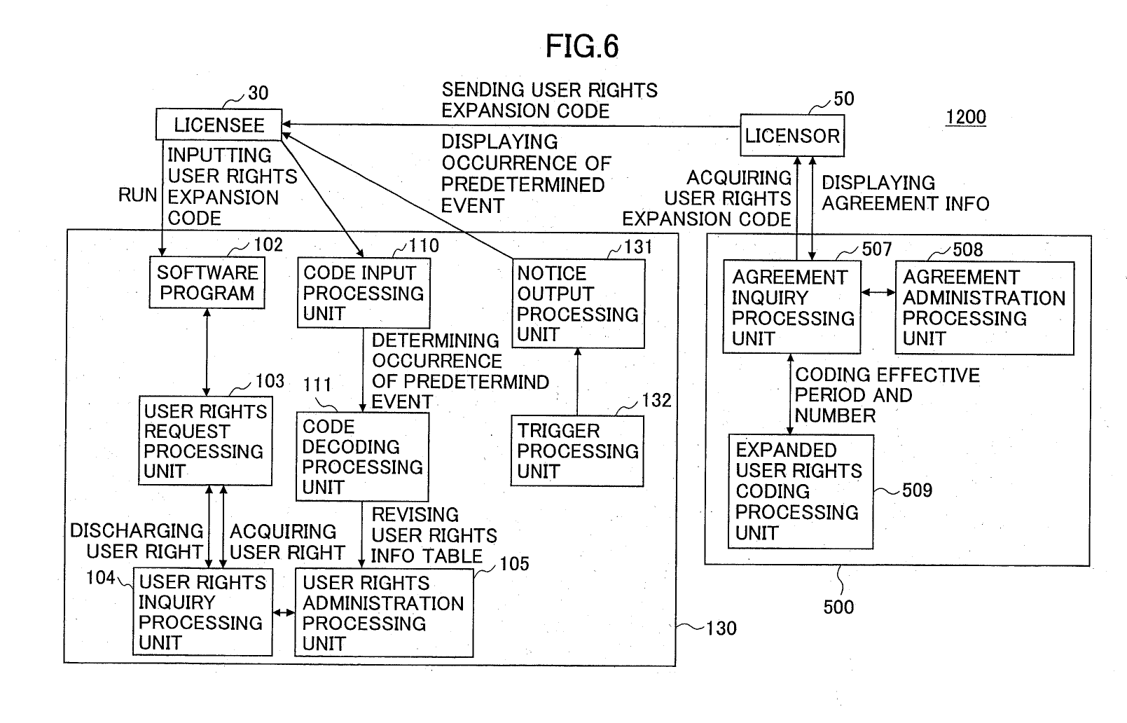

FIG. 6 is a schematic drawing showing the configuration of the user rights administrative system as the second embodiment. The units that have been described in connection with FIG. 1 are referred to by the same numerals and their description will be omitted.

An administrative system of user rights 1200 shown in FIG. 6 includes a software user rights administrative apparatus 130 that the licensee 30 operates and a software agreement administrative apparatus 500 that the licensor 50 who makes the volume licensing agreement with the licensee 30 operates.

The hardware configuration of the software user rights administrative apparatus 130 is the same as that of the software user rights administrative apparatus 100 shown in FIG. 2.

The software user rights administrative apparatus 130 includes the software program 102, the user rights request processing unit 103, the user rights inquiry processing unit 104, the user rights administration processing unit 105, the code input processing unit 110, the code decoding processing unit 111, a notice output processing unit 131, and a trigger processing unit 132.

The notice output processing unit 131, in response to a notice from the trigger processing unit 132, informs the licensee 30 that an event stipulated in the volume licensing agreement has occurred by displaying a message on the display unit 15.

The trigger processing unit 132 determines whether any event stipulated in the volume licensing agreement has occurred and informs the notice output processing unit 131 of the occurrence.

The software agreement administrative apparatus 500 includes the agreement inquiry processing unit 507, the agreement administration processing unit 508, and the expanded user rights coding processing unit 509. Each unit has the same function as the corresponding unit of the software agreement administrative apparatus 500 shown in FIG. 1.

In the second embodiment described above, the number of user rights can be expanded by performing the user rights expansion process described above in connection with the first embodiment shown in FIG. 4.

The user rights information table 120 shown in FIG. 5 is also used in the second embodiment. When the effective period is over, the maximum number of user rights is set at the original number.

[Third Embodiment]

An administrative system of user rights in which a notice is sent to the licensor 50 when an event stipulated in the volume licensing agreement occurs will be explained below.

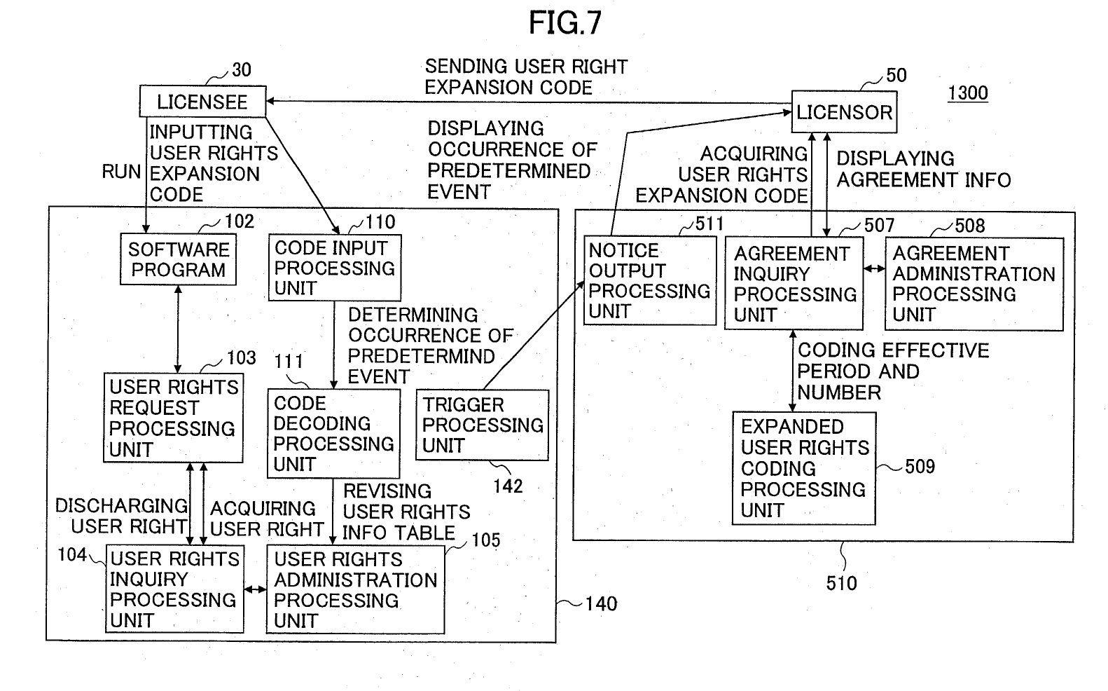

FIG. 7 is a schematic drawing showing the administrative system of user rights as the third embodiment of the present invention. In FIG. 7, the components that have been described in FIG. 1 are referred to by the same numerals, and their description will be omitted.

A user rights administrative system 1300 includes a software user rights administrative apparatus 140 that is operated by the licensee 30 of the software program 102 and a software agreement administrative apparatus 510 that is operated by the licensor 50 who makes the volume licensing agreement of the software program with the licensee 30.

The hardware configuration of the software user rights administrative apparatus 140 and the software agreement administrative apparatus 510 is the same as that of the software user rights administrative apparatus 100 and the software agreement administrative apparatus 500 shown in FIG. 2.

The software user rights administrative apparatus 140 includes the software 102, the user rights request processing unit 103, the user rights inquiry processing unit 104, the user rights administration processing unit 105, the code input processing unit 110, the code decoding processing unit 111, and a trigger processing unit 142.

The trigger processing unit 142 determines whether one or more events stipulated in the volume licensing agreement have occurred and informs a notice output processing unit 511 provided in the software agreement administrative apparatus 510.

The notice output processing unit 511 informs, in response to a notice of the event occurrence from the trigger processing unit 142 of the software user rights administrative apparatus 140, the licensor 50 of the event occurrence by displaying a message indicating that the events stipulated in the volume licensing agreement have occurred using the display unit 15.

The licensor 50 requests the agreement inquiry processing unit 507 for the coding of expanded user rights. The agreement inquiry processing unit 507 searches agreement information in the agreement administration processing unit 508 and converts the agreement information into an identification code using the expanded user rights coding processing unit 509 that is installed as an encoding module of the agreement information. The licensor 50 transfers the identification code to the licensee 30.

The number of the user rights can be expanded in the third embodiment by performing the user rights expansion process shown in FIG. 4.

The user rights information table 120 shown in FIG. 5 is used in the third embodiment as it is used in the first embodiment. When the effective period of the user rights expansion is over, the maximum number of user rights is automatically set at the original number.

[Fourth Embodiment]

A user rights administrative system in which the licensee 30 is informed of the occurrence of predetermined events through a software agreement administrative apparatus will be described below.

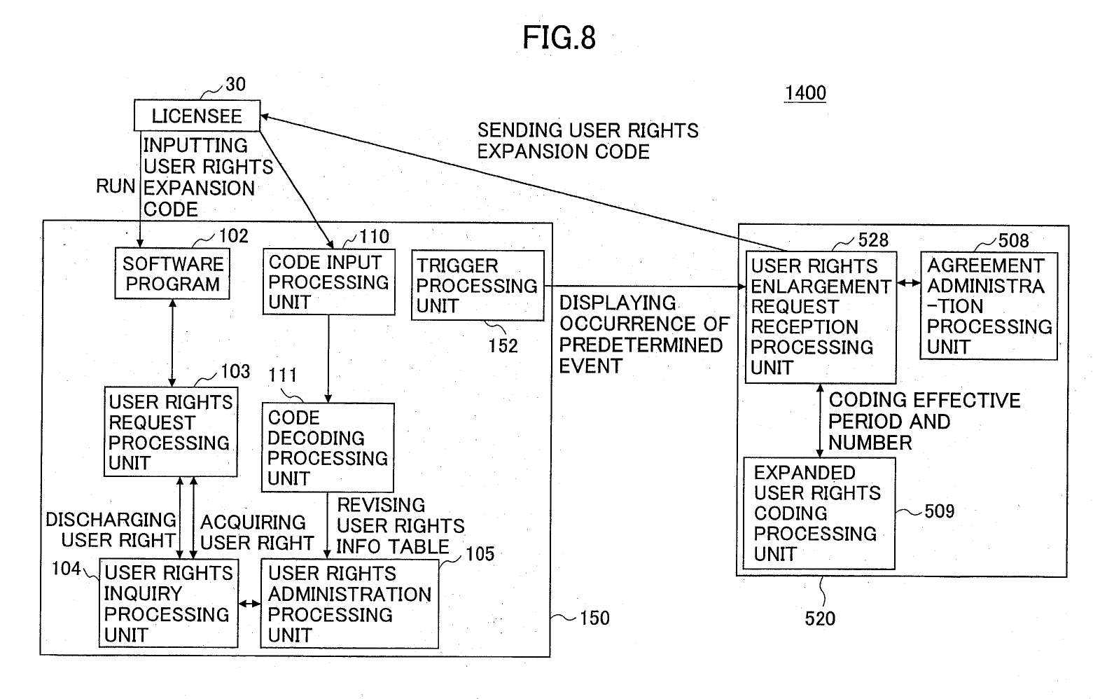

FIG. 8 is a schematic drawing showing an administrative system of user rights as the fourth embodiment. The components which are identical to those in FIG. 7 are referred to by the same numerals, and their description will be omitted.

The user rights administrative system 1400 includes the software user rights administrative apparatus 150 that is used by the licensee 30 and a software agreement administrative apparatus 520 that administers the volume licensing agreement with the licensee 30.

The hardware configurations of the software user rights administrative apparatus 150 and the software agreement administrative apparatus 520 are identical to those of the software user rights administrative apparatus 100 and the software agreement administrative apparatus 500 shown in FIG. 2.

The software user rights administrative apparatus 150 includes a software program 102, a user rights request processing unit 103, a user rights inquiry processing unit 104, a user rights administration processing unit 105, a code input processing unit 110, a code decoding processing unit 111, and a trigger processing unit 152.

The trigger processing unit 152 determines whether one or more predetermined events have been occurred, and informs the user rights expansion request reception processing unit 528 of the software agreement administrative apparatus 520 of the occurrence.

The software agreement administrative apparatus 520 includes the user rights expansion request reception processing unit 528, an agreement administration processing unit 508, and an expanded user rights coding processing unit 509.

The user rights expansion request reception processing unit 528, in response to a notice of the occurrence of the predetermined events, searches agreement information corresponding to the events in the agreement administration processing unit 508, and converts the agreement information into an identification code using the expanded user rights coding processing unit 509 that is installed as an encoding module of the agreement information. The identification code is sent to the licensee 30.

The number of user rights is expanded by performing the user rights expansion process described in connection with the first embodiment as shown in FIG. 4.

The user rights information table 120 shown in FIG. 5 is also used in this embodiment. Once the effective period is over, the maximum number of user rights is automatically set at the original one.

[Fifth Embodiment]

A user rights administrative system in which the licensor 50 or a software agreement administrative apparatus expands the number of user rights without requiring the licensee 30 to perform special operation.

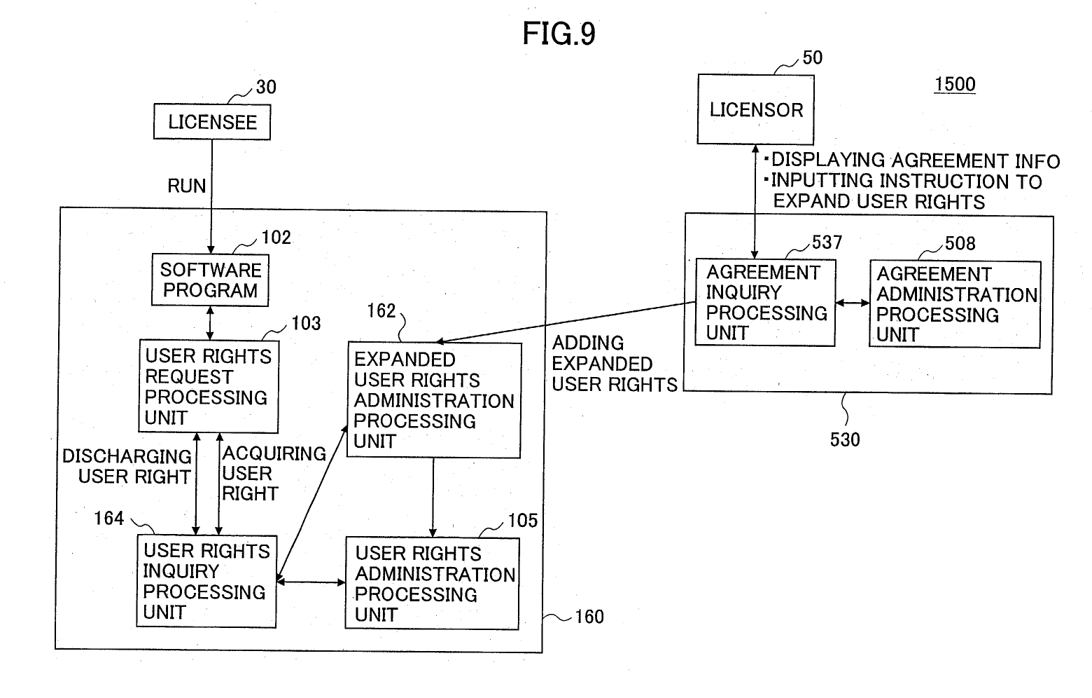

FIG. 9 is a schematic drawing showing a user rights administrative system as the fifth embodiment of the present invention. The components that have been introduced with connection to FIG. 1 are referred to by the same numerals as FIG. 1 and their explanation will be omitted.

A user rights administrative system 1500 includes a software user rights administrative apparatus 160 that is operated by the licensee 30 and a software agreement administrative apparatus 530 that is operated by the licensor 50 and makes the volume licensing agreement with the licensee 30.

The hardware configurations of the software user rights administrative apparatus 160 and the software agreement administrative apparatus 530 are the same as those of the software user rights administrative apparatus 100 and the software agreement administrative apparatus 500 shown in FIG. 2.

The user rights administrative apparatus 160 includes a software program 102, a user rights request processing unit 103, a user rights inquiry processing unit 164, a user rights administration processing unit 105, and an expanded user rights administration processing unit 162.

If the user rights inquiry processing unit 164 receives an acquisition request for a user rights from the user rights request processing unit 103, but cannot acquire an unused user right by searching the user rights information table in the user rights administration processing unit 105, the user rights inquiry processing unit 164 further searches and obtains an unused expanded user right in the expanded user rights administration processing unit 162.

The expanded user rights administration processing unit 162 administers expanded user rights information. The expanded user rights administration processing unit 162 receives the expanded user rights information sent from the software agreement administrative apparatus 530 through the network, for example, and stores the expanded user rights information therein.

The software agreement administrative apparatus 530 includes an agreement administration processing unit 508 and an agreement inquiry processing unit 537.

The agreement inquiry processing unit 537, in response to an instruction to expand the number of user rights from the licensor 50, searches agreement information corresponding to the instruction in the agreement administration processing unit 508. The expanded user rights information is added, if possible, to the agreement administration processing unit 508. For example, the agreement inquiry processing unit 537 provides the expanded user rights administration processing unit 162 with the expanded user rights information.

In the fifth embodiment described above, the licensee 30 is not required to perform any operation to acquire expanded user rights.

The acquisition process of user rights performed in the fifth embodiment is described next.

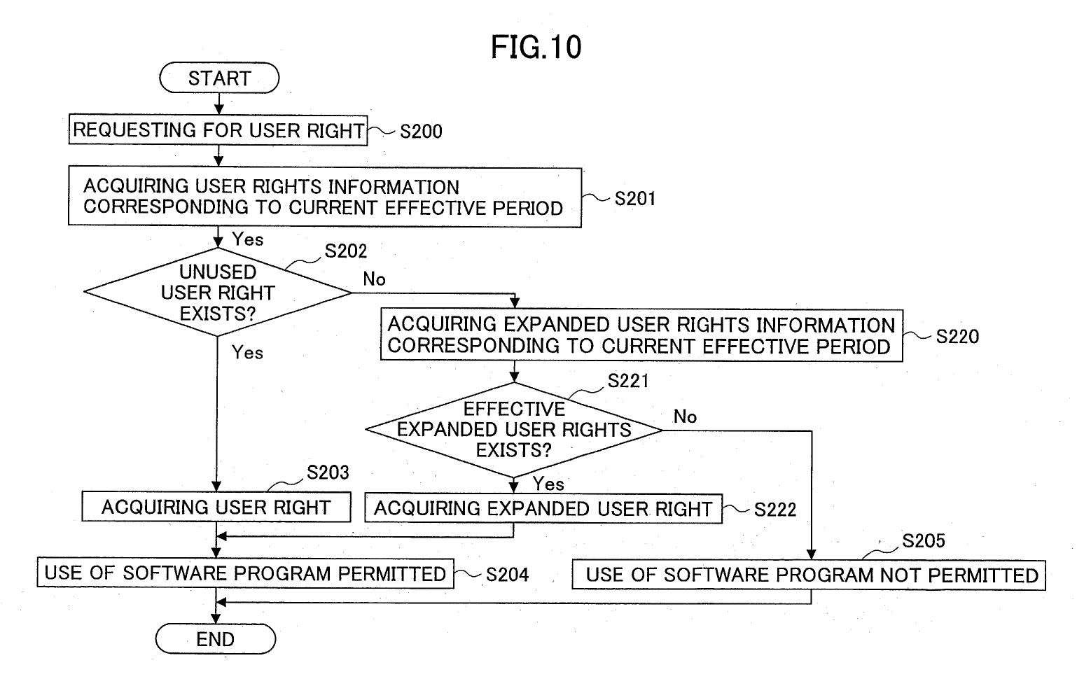

FIG. 10 is a flow diagram showing the user rights acquisition process of the fifth embodiment.

When an end-user of the licensee 30 activates the software program 102, the software program 102 requests for a user right through the user rights request processing unit 103 (S200).

The user rights inquiry processing unit 164 searches the user rights administration processing unit 105 (S201), and determines whether any unused user rights exist by comparing the maximum number of users using the software program 102 simultaneously and the number of users currently using the software program 102 (S202). If any unused user right exists, a user right is assigned to the licensee 30 and the user rights request processing unit 103 is notified of the assignment (S203). The user rights request processing unit 103 permits the end-user of the licensee 30 to use the software program 102 (S204).

If no unused user right is available, the user rights inquiry processing unit 164 further searches the expanded user rights administration processing unit 162 (S220), and determines whether expanded user rights information effective as of the day of the request is stored in the expanded user rights administration processing unit 162 and whether an unused user right exists by comparing the maximum number of users using the software program 102 simultaneously and the number of users currently using the software program 102 (S221). If an expanded user right is left unused, the expanded user right is assigned to the end-user of the licensee 30 and the user rights request processing unit 103 is notified of the assignment (S222). The user rights request processing unit 103 permits the end-user of the licensee 30 to use the software program 102 (S204). If no expanded user right is available, the end-user of the licensee 30 is prevented from using the software program 102 (S205).

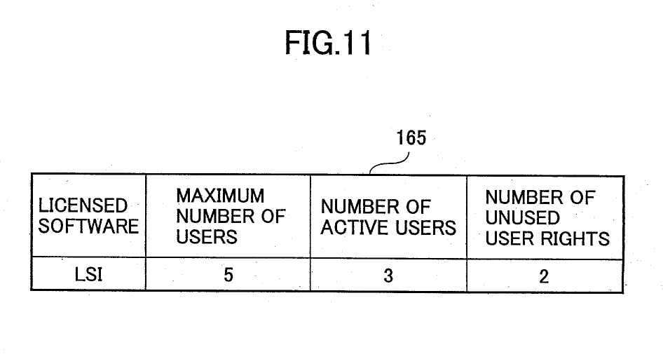

FIG. 11 is an example of a user rights information table used in the fifth embodiment. The user rights information table 165 includes a column “Licensed Software” indicating the name of the software program 102 that is licensed to the licensee 30, a column “Maximum Number of Users” that can use the software program 102 simultaneously, a column “Number of Active Users” who are using the software program 102 at the point of time, and a column “Number of Unused User Rights” indicating the number of users who can additionally use the software program 102.

In the user rights information table 165 shown in FIG. 11, for example, indicates “LS1” as the “Licensed Software”, “5” as the “Maximum Number of Users”, “3” as the “Number of Active Users”, and “2” as the “Number of Unused User Right”.

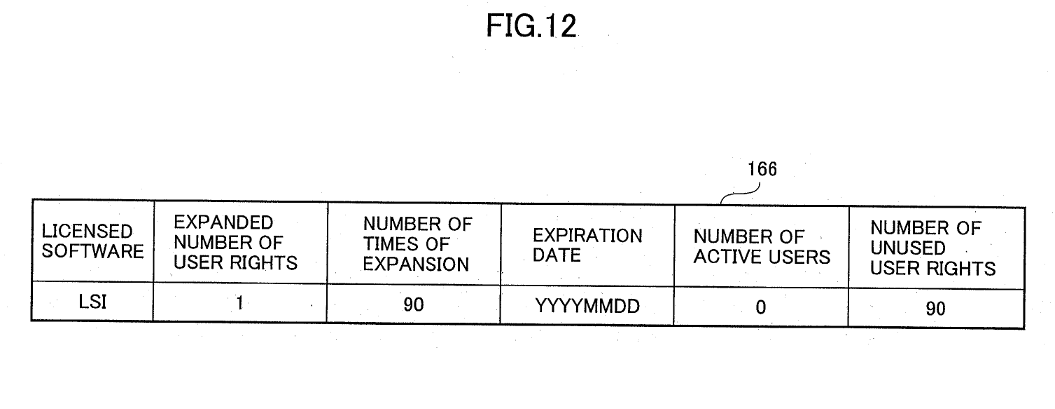

FIG. 12 is an example of an expanded user rights information table of the fifth embodiment. The expanded user rights information 166 includes a column “Licensed Software” indicating the name of the software program 102 that is licensed to the licensee 30, a column “Expanded number of User Rights” indicating the number of user rights expanded, a column “Number of Times of Expansion” the licensee 30 has used the expanded user rights, a column “Expiration Date” on which the effective period is over, a column “Number of Active Users” indicating the number of users currently using the software program 102, and a column “Number of Unused User Rights” indicating the number of user rights being left unused.

The expanded user right information table 166 shown in FIG. 12 indicates “LS1” as the “Licensed Software”, “90” as the “Number of Times of Expansion”, “1” as “Number of Enlarged User Rights”, “YYYYMMDD” (YYYY, MM, DD indicate a year, a month, and a day, respectively) as “Expiration Date”, “0” as “Number of Active Users”, and “90” as “Number of Unused User Rights”.

[Sixth Embodiment]

A user rights administrative system in which a software agreement administrative apparatus informs, by directly accessing, a software user rights administrative apparatus of an occurrence of a predetermined event stipulated in the volume licensing agreement will be described next.

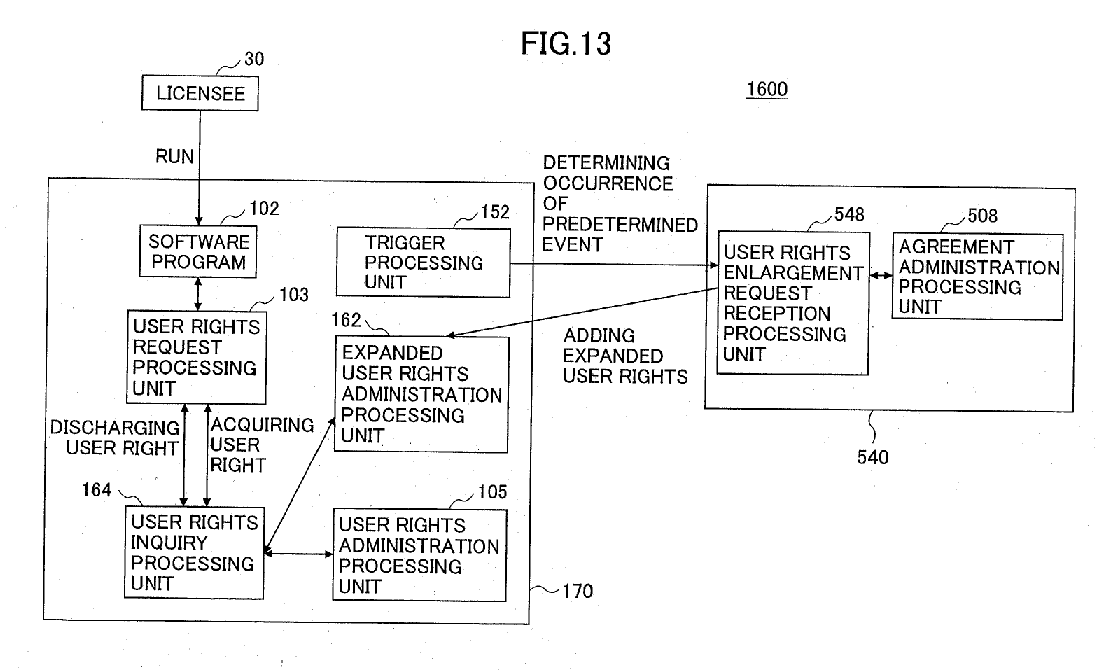

FIG. 13 is a schematic drawing showing an administrative system of user rights as the sixth embodiment of the present invention. The components that have been introduced in connection with FIG. 8 and/or FIG. 9 will be referred to by the same numerals, and their description will be omitted.

In FIG. 13, a user rights administrative system 1600 includes a software user rights administrative apparatus 170 that is operated by the licensee 30 and a software agreement administrative apparatus 540 that administers the volume licensing agreement with the licensee 30.

The software user rights administrative apparatus 170 and the software agreement administrative apparatus 540 have the same hardware configuration shown in FIG. 2 that is the hardware configuration of both the software user rights administrative apparatus 100 and the software agreement administrative apparatus 500.

The software user rights administrative apparatus 170 includes a software program 102, a user rights request processing unit 103, a user rights inquiry processing unit 164, a user rights administration processing unit 105, an expanded user rights administration processing unit 162, and a trigger processing unit 152.

The software agreement administrative apparatus 540 includes a user rights expansion request reception processing unit 548 and an agreement administration processing unit 508.

In the sixth embodiment, the trigger processing unit 152 determines whether one or more predetermined events stipulated in the volume licensing agreement have occurred, and informs the user rights expansion request reception processing unit 548 in the software agreement administrative apparatus 540 of the occurrence. For example, the trigger processing unit 152 informs the user rights expansion request reception processing unit 548 of the occurrence using the communication unit 18 of the software user rights administrative apparatus 170 through a network.

The user rights expansion request reception processing unit 548, in response to the receipt of information of the occurrence, searches agreement information corresponding to the event in the agreement administration processing unit 508, and adds expanded user rights information to the expanded user rights administration processing unit 162 of the software user rights administrative apparatus 170. For example, the user rights expansion request reception processing unit 548 provides the expanded user rights administration processing unit 162 with the expanded user rights information using the communication unit 18 of the software agreement administrative apparatus 540.

The user rights request processing unit 103 in the software user rights administrative apparatus 170 that is operated by the licensee 30 is activated to request for a user right, and searches expanded user rights information effective as of the day of request in the expanded user rights administration processing unit 162. If the information of effective expanded user rights is found, the number of expanded user rights currently used and the number of unused expanded user rights are calculated and the expanded user rights information table 166 is revised.

In the sixth embodiment, the process from the event occurrence to the expansion of the user rights is performed automatically.

[Seventh Embodiment]

In the seventh embodiment, identification information corresponding to the volume licensing agreement is stored in a user rights administration processing unit. If one or more predetermined events occur, the number of user rights is permitted by verifying the identification information.

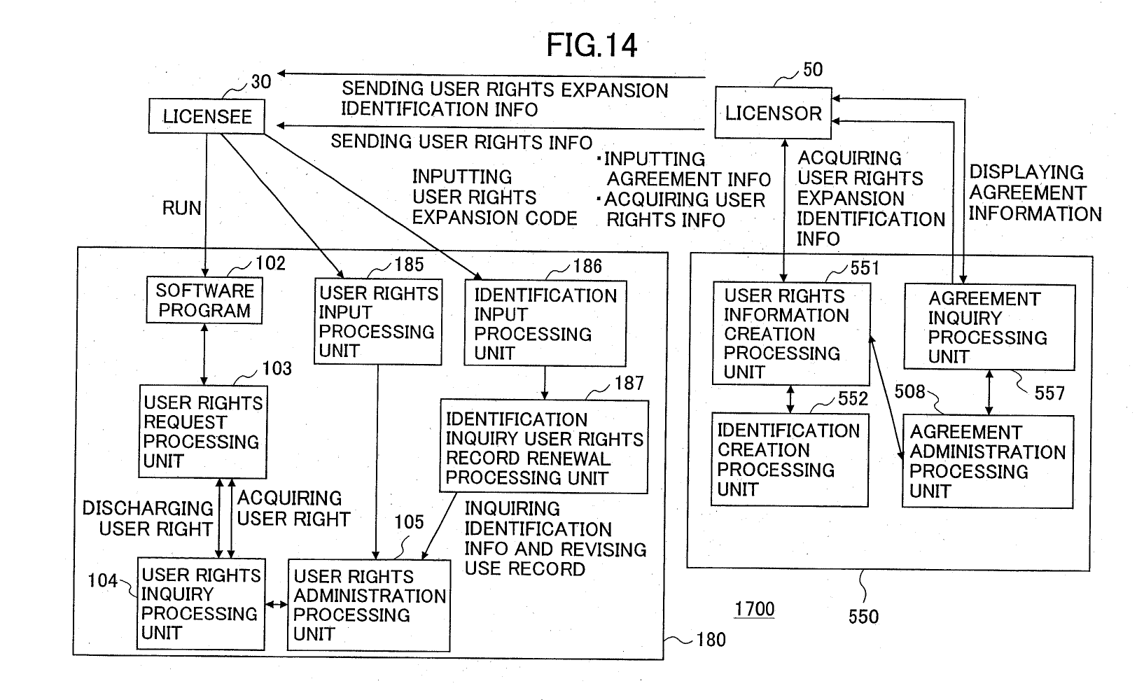

FIG. 14 is a schematic drawing showing an administrative system of user rights of the seventh embodiment. The components which are identical to those of the user rights administrative system 1000 shown in FIG. 1 are referred to by the same numerals, and their description will be omitted.

A user rights administrative system 1700 shown in FIG. 14 includes a software user rights administrative apparatus 180 that is operated by the licensee 30 of the software program 102 and a software agreement administrative apparatus 550 that is operated by the licensor 50 who makes the volume licensing agreement with the licensee 30.

The software user rights administrative apparatus 180 and the software agreement administrative apparatus 550 have the same hardware configuration shown in FIG. 2 as the software user rights administrative apparatus 100 and the software agreement administrative apparatus 500.

The software user rights administrative apparatus 180 includes a software program 102, a user rights request processing unit 103, a user rights inquiry processing unit 104, a user rights administration processing unit 105, a user rights input processing unit 185, an identification input processing unit 186, and an identification inquiry user rights information renewal processing unit 187.

The software agreement administrative apparatus 550 includes a user rights information creation processing unit 551, an identification creation processing unit 552, an agreement inquiry processing unit 557, and an agreement administration processing unit 508.

When the licensee 30 purchases the software program 102 or additional user rights of the software program 102, the licensor 50 inputs license agreement information to the user rights information creation processing unit 551.

The user rights information creation processing unit 551 requests from the identification creation processing unit 552 a creation of identification information that is unique to the volume licensing agreement.

The identification creation processing unit 552 creates unique identification information, and sends the identification information to the user rights information creation processing unit 551.

The user rights information creation processing unit 551 stores the license agreement information and the identification information that is sent from the identification creation processing unit 552 in the agreement administration processing unit 508. The user rights information creation processing unit 551 edits the user rights information based on the identification information.

The licensor 50 sends the user rights information edited and output by the user rights information creation processing unit 551 to the licensee 30. The licensee 30 inputs the user rights information to the user rights input processing unit 185. The user rights input processing unit 185 has the user rights administration processing unit 105 administer the user rights information input.

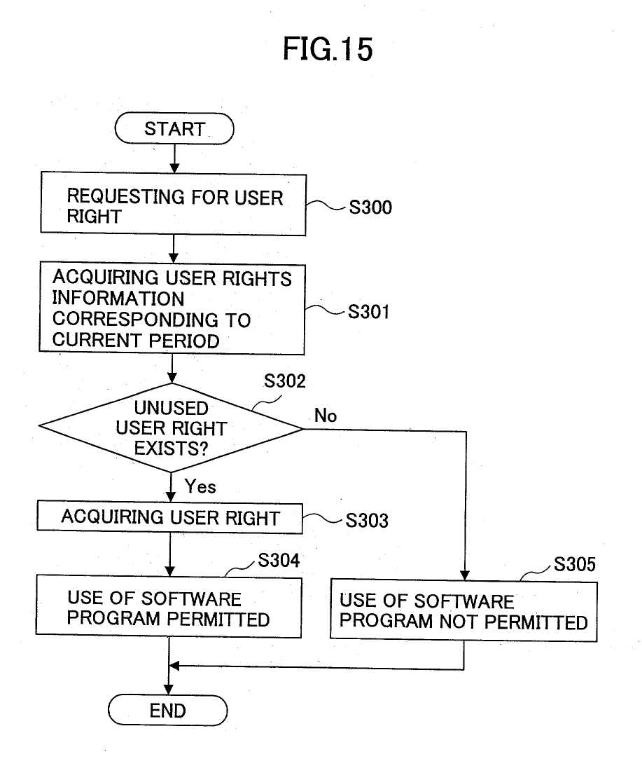

FIG. 15 is a flow diagram showing the user rights inquiry process of the seventh embodiment. When an end-user of the licensee 30 activates the software program 102, the software program 102 activates the user rights request processing unit 103 and requests for a user right (S300).

The user rights inquiry processing unit 104 searches the user rights administration processing unit 105 (S301), and determines whether any user right being left unused is available by checking the maximum number of users that can use the software program 102 simultaneously and the number of current users currently using the software program 102 (S302). If an unused user right is available for use, a user right is assigned to the end-user of the licensee 30 and the user rights request processing unit 103 is notified of the assignment (S303). The user rights request processing unit 103 permits the end-user of the licensee 30 to use the software program 102 (S304).

If no unused user right is available, the use of the software program 102 is not permitted (S305). The end-user of the licensee 30 is prevented from using the software program 102.

If one or more predetermined events have occurred, the following processing is performed.

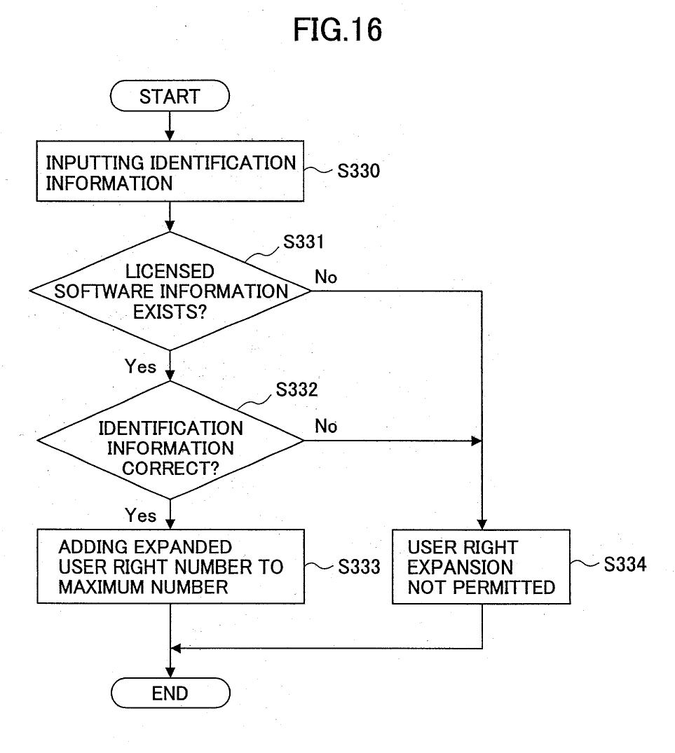

FIG. 16 is a flow diagram showing the processing after the predetermined events have occurred in the seventh embodiment. Once one or more predetermined events have occurred, the licensor 50 instructs the agreement inquiry processing unit 557 to display license agreement information. The agreement inquiry processing unit 557 searches the license agreement information in the agreement administration processing unit 508 and displays the license agreement information on the display unit 16. The licensor 50 informs the licensee 30 of the identification information. The licensee 30 inputs the identification information to the identification input processing unit 186 (S330).

The identification input processing unit 186 sends the identification information to the identification inquiry user rights information renewal processing unit 187. The identification inquiry user rights information renewal processing unit 187 searches the user rights information connected to the software program 102 in the user rights administration processing unit 105 (S331), and verifies the input identification information (S332). If the input identification information is incorrect, no expanded user right is granted to the licensee 30 (S334).

If the input identification information is verified, the identification inquiry user rights information renewal processing unit 187 revises the user rights information of the user rights administration processing unit 105 by increasing the maximum number of users who can use the software program 102 simultaneously by the number of expanded user rights (S333).

When the user rights request processing unit 103 is activated, the number of unused user rights is calculated based on the expanded maximum number of users.

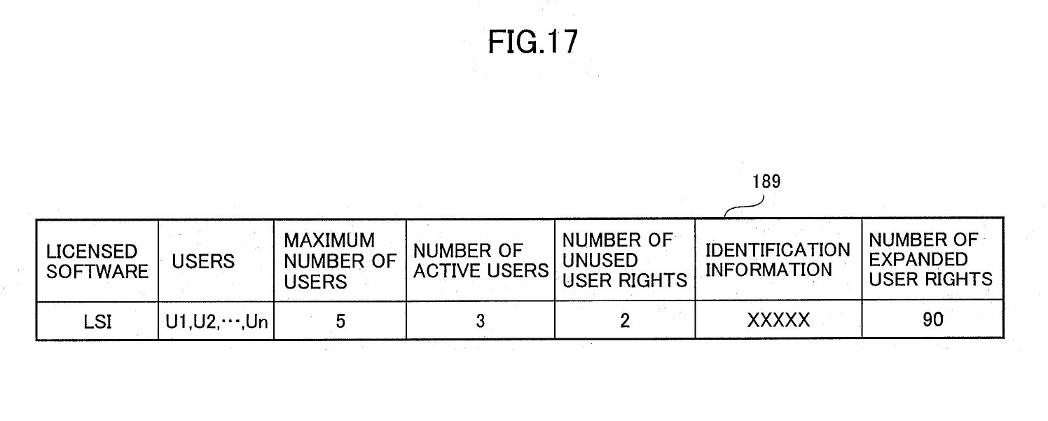

FIG. 17 shows an example of an expanded user rights information table used in the seventh embodiment. An expanded user rights information table 189 that is administered by the user rights administration processing unit 105 includes a column “Licensed Software” indicating the name of the licensed software program 102, a column “Users” indicating user identifications of users who are authorized to use the software program 102, a column “Maximum Number of Users” who can use the software program 102 simultaneously, a column “Number of Active Users” who are using the software program 102 at the point of time, a column “Number of Unused User Rights” that are not used at the point of time, a column “Identification Information” that has made the expansion of user rights effective, and a column “Expanded Number of User Rights” indicating the maximum number of additional user rights.

In the user rights information table 189 shown in FIG. 17, for example, indicates that the users “U1”, “U2”, . . . , “Un” are authorized to use the licensed software program “LS1”. The maximum number of users is “5”, the number of current users is “3”, and the number of unused users is “2”. Furthermore, if the identification “XXXXX” is verified, the expanded number of user rights “90” is added to the maximum number of users “5”, then the total of 95 users is to be authorized to use the licensed software program “LS1”.

In the case of the seventh embodiment, identification information that authorizes the expansion in user rights is stored in the user rights administration processing unit when the volume licensing agreement is made, the licensee 30 can expand the user rights when one or more predetermined events have occurred. Accordingly, the licensee 30 can expand the number of user rights any time without taking the effective period of user rights expansion into account.

[Eighth Embodiment]

When the licensee 30 installs the software program 102 or executes it for the first time, the licensee 30 is required to register a user rights number corresponding to the software program 102. The user rights number is input to the software user rights administrative apparatus, and sent for a registration to the software agreement administrative apparatus that is operated by the licensor 60. If one or more predetermined events occur, the number of user rights is expanded by reference to the user rights number.

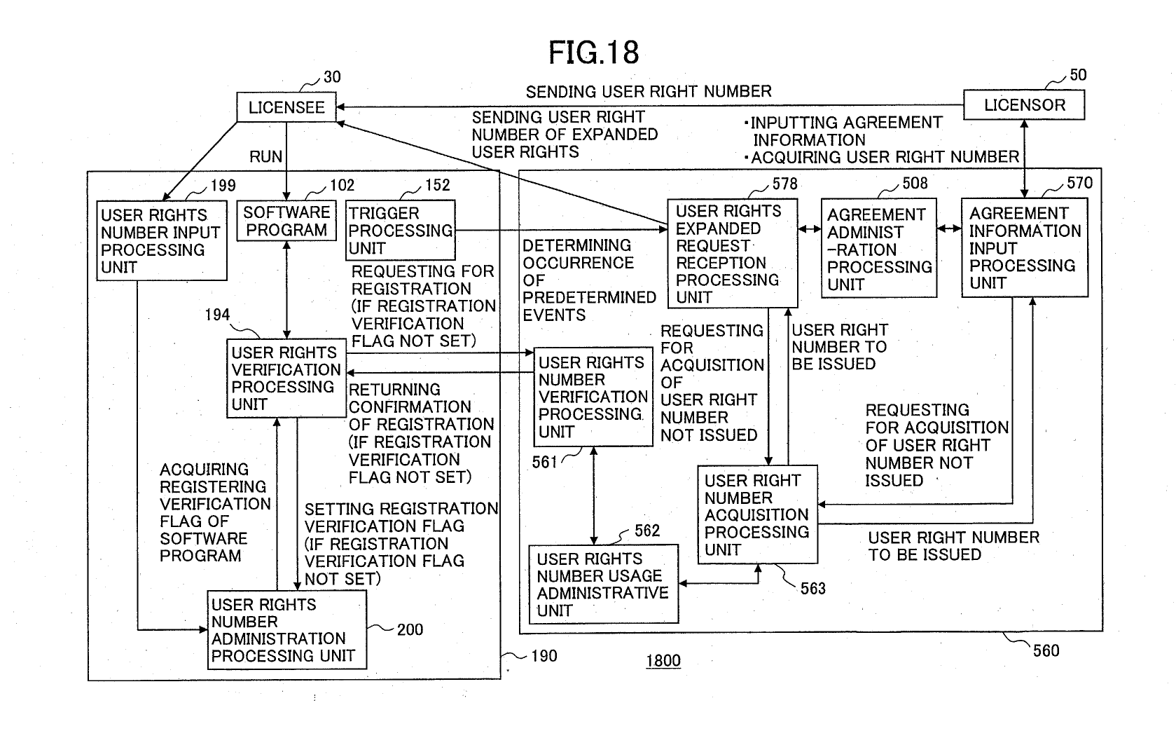

FIG. 18 is a schematic drawing showing a user rights administrative system as the eighth embodiment. The components which are identical to those shown in FIG. 1 are referred to by the same numerals, and their explanations are omitted.

A user rights administrative system 1800 shown in FIG. 18 includes a software user rights administrative apparatus 190 that is operated by the licensee 30 and a software agreement administrative apparatus 560 that is operated by the licensor 50 who makes the volume licensing agreement with the licensee 30.

The software user rights administrative apparatus 190 and the software agreement administrative apparatus 560 have the same hardware configuration shown in FIG. 2 as the software user rights administrative apparatus 100 and the software agreement administrative apparatus 500.

The software user rights administrative apparatus 190 includes a software program 102, a trigger processing unit 152, a user rights verification processing unit 194, a user rights number input processing unit 199, and a user rights number administration processing unit 200.

The software agreement administrative apparatus 560 includes an agreement administration processing unit 508, a user rights number verification processing unit 561, a user rights number usage administrative unit 562, a user rights number acquisition processing unit 563, an agreement information input processing unit 570, and a user rights expansion request reception processing unit 578.

When the software program 102 is installed or the licensee 30 purchases additional user rights, the licensor 50 inputs agreement information to the agreement information input processing unit 570.

The agreement information input processing unit 570 registers the agreement information to the agreement administration processing unit 508, and at the same time, requests the user rights number acquisition processing unit 563 to acquire the user rights number of the software program 102, which is not issued yet.

The user rights number acquisition processing unit 563 searches the user rights number usage administration processing unit 562 for the user rights numbers of the software program 102 which are not issued yet, and sets the flags of the user rights number usage administration processing unit 562 indicating the user rights number is already issued.

When the user rights number acquisition processing unit 563 informs the agreement information input processing unit 570 of the user rights number, the agreement information input processing unit 570 outputs the user rights number to the licensor 50.

The licensor 50 informs the licensee 30 of the user rights number output by the agreement information input processing unit 570.

When the licensee 30 installs the software program 102 in its terminal, the licensee 30 is required to input the user rights number of the software program 102, to the user rights number input processing unit 199, of which the licensor 50 has informed the licensee 30. The user rights number input processing unit 199 stores, in the user rights administration processing unit 200, and administers the user rights number input by the licensee 30.

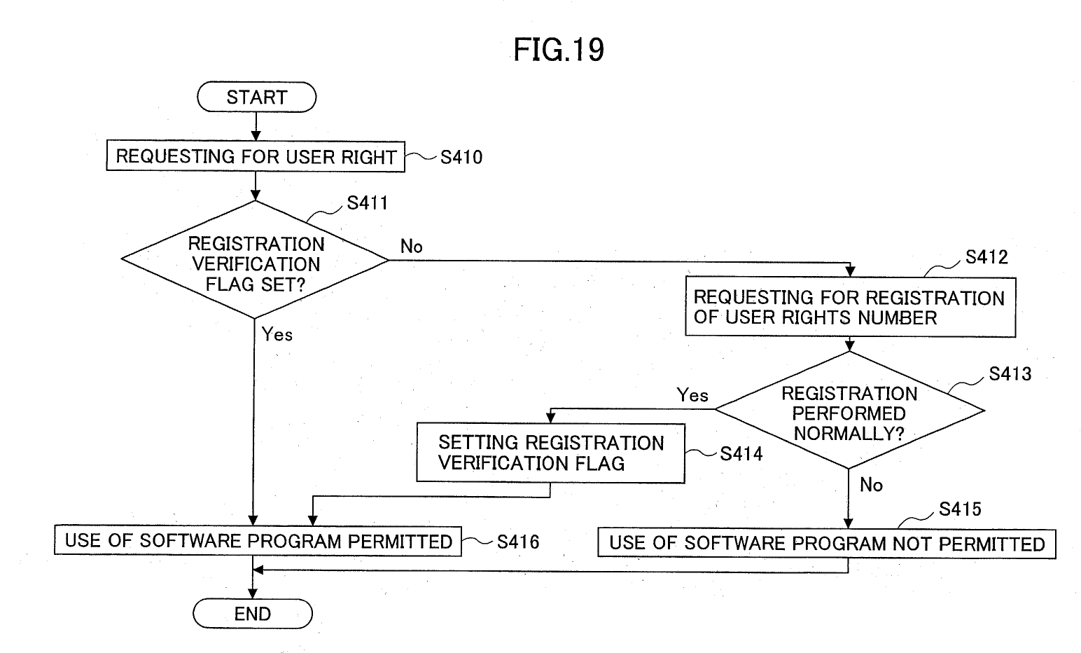

FIG. 19 is a flow diagram showing user rights verification processing of the eighth embodiment. When the licensee 30 executes the software program 102, the software program 102 activates the user rights verification processing unit 194 and requests a user right (S410).

The user rights verification processing unit 194 searches the user rights number administration processing unit 200 and acquires registration verification flag of the software program 102. Furthermore, the user rights verification processing unit 194 checks whether the registration verification flag is set (S411). If the flag is already verified, the use of the software program is permitted (S416).

If the registration verification flag of the software program 102 is not verified yet at the decision S411, the user rights verification processing unit 194 requests, through the network, the user rights number verification processing unit 561 of the software agreement administrative apparatus 560 for the registration of the user rights number (S412).

If the registration is performed normally, the user rights verification processing unit 194 sets the registration verification flag of the user rights number administration processing unit 200 to a state indicating the user rights number is registered (S414), and the use of the software program 102 is permitted (S416).

If the registration has failed, the licensee 30 is prevented from using the software 102 (S415).

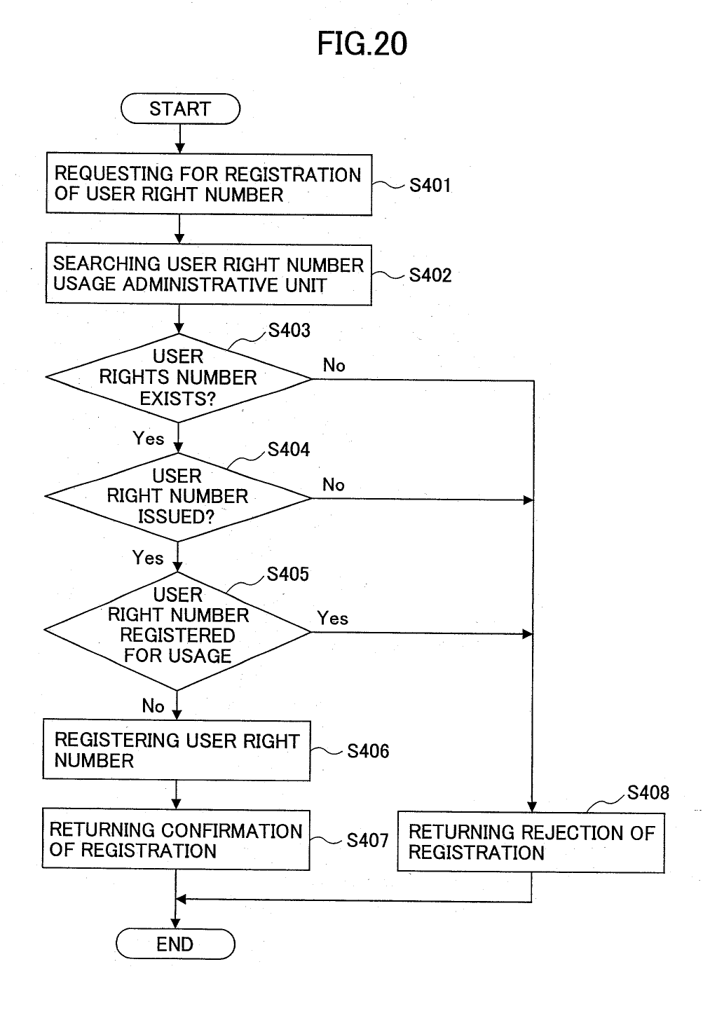

FIG. 20 is a flow diagram showing the user rights registration processing of the eighth embodiment. In the case that the registration verification flag of the software program 102 is not verified at the step S411 of FIG. 19, the user rights verification processing unit 194 requests the user rights number verification processing unit 561 of the software agreement administrative apparatus 560 for the registration of the user rights number (S401).

The user rights number verification processing unit 561 searches the user rights number usage administration processing unit 562 (S402), and determines whether the user rights number exists (S403). If the user rights number does not exist, the user rights number verification processing unit 561 returns a message indicating rejection of the registration to the software user rights administrative apparatus 190 (S408).

If the user rights number exists, the user rights number verification processing unit 561 determines whether the user rights number has been issued (S404). If the user rights number has not been issued yet, the user rights number verification processing unit 561 returns a message indicating rejection of the registration to the software user rights administrative apparatus 190 (S408).

If the user rights number has been issued, the user rights number verification processing unit S561 determines whether the user rights number has been registered for usage (S405). If the user rights number has been registered for usage, the user rights number verification processing unit 561 return a message indicating rejection for the registration to the software user rights administrative apparatus 190 (S408).

If the user rights number has not been registered for usage, the user rights number verification processing unit 561 sets the flag corresponding to the user rights number indicating the user rights has been registered of the user rights number usage administrative processing unit 562 (S406), and informs the user rights verification processing unit 194 that the registration has been performed (S407).

In the eighth embodiment, if one or more predetermined events occur, the trigger processing unit 152 determines the occurrence of the events, and informs the user rights expansion request reception processing unit 578 of the licensor 50 of the occurrence of the events.

The user rights expansion request reception processing unit 578 searches the agreement information in the agreement administration processing unit 508, and acquires the number of the user rights numbers of the software program 102. The user rights expansion request reception processing unit 578 requests the user rights number acquisition processing unit 563 for the acquisition of user rights numbers which are not issued yet.

The user rights number acquisition processing unit 563 searches the user rights number usage administration processing unit 562 and acquires the user right number that has not been issued yet. The user rights number acquisition processing unit 563 further sets the flag corresponding to the user right number of the user rights number usage administration processing unit 562 indicating the user right has been issued.

The user rights number acquisition processing unit 563 informs the user rights expansion request processing unit 578 of the user right number acquired. The user rights expansion request reception processing unit 578 sends the user right numbers of expanded user rights acquired to the licensee 30.

The licensee 30 can expand the number of user rights, that is, expand the number of user terminals in which the software program 102 is installed, using the user right numbers sent by the user rights expansion request reception processing unit 578.

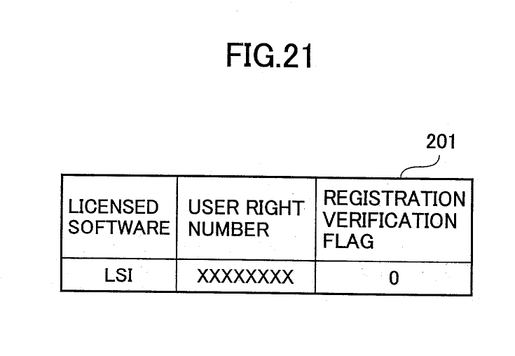

FIG. 21 is an example of user rights number table of the eighth embodiment. A user rights number table 201 that is administered by the user rights number administration processing unit 200 has a column “Licensed Software” indicating the name of the software program licensed, a column “User Right Number”, and a column of flag indicating the user right number has been registered, etc.

The user rights number table 201 shown in FIG. 21 shows, for example, that the registration verification flag of the user right number “XXXXX” of the licensed software program “LS1” is set “0” (not registered yet).

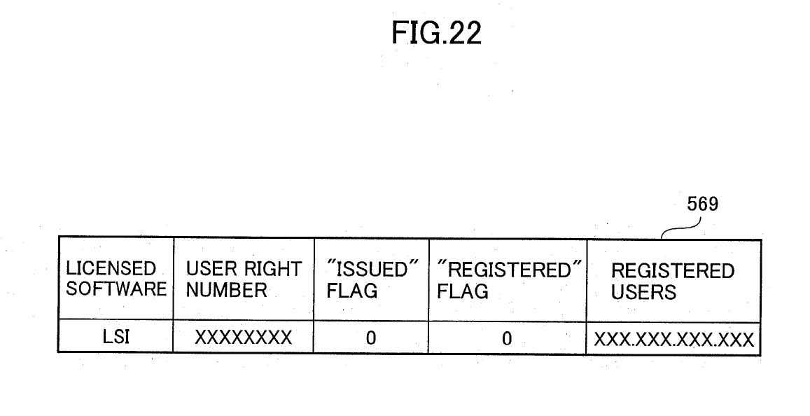

FIG. 22 is an example of a user rights registration table of the eighth embodiment. In FIG. 22, the user rights registration table 569 that is administered by the user rights number usage administration processing unit 562 includes a column “Licensed Software”, a column “User Right Number”, a column of flag indicating that the user right number has been issued, a column of flag indicating that the user right number has been registered, and a column “Registered User”.

The user rights registration table 569 in FIG. 22 shows that the issuance flag of the user right number “XXXXX” of the registered user “XXX.XXX.XXX.XXX” of the licensed software program “LS1” is set “0” (not issued yet), and its registration flag is set “0” (not registered yet).

In the above embodiment, the software agreement administrative apparatus 560 administers the agreement information and user rights connected to the volume licensing agreement between the licensor 50 and the licensee 30. The licensee 30 can expand the number of the user rights by inputting a predetermined code or identification information to the software user rights administrative apparatus 190. Accordingly, the licensee 30 is not required to purchase user rights or modify volume licensing agreement by following the ordinary procedure of the organization such as a company, in an emergency. The licensee 30 can expand the number of user rights without taking time for in-house clerical procedures.

The preferred embodiments of the present invention are described above. The present invention is not limited to these embodiments, but various variations and modifications may be made without departing from the scope of the present invention.

This patent application is based on Japanese priority patent application No. 2001-136477 filed on May 7, 2001, the entire contents of which are hereby incorporated by reference.

What is claimed is:

1. A method of administering user rights of a software program that can be increased in number, comprising:
a step of a user right administrative apparatus of determining whether a predetermined event has occurred;
a step of said user right administrative apparatus of informing a licensee of the occurrence of said predetermined event;
a step of said licensee of acquiring expansion information that causes said user right administrative apparatus to revise user right information indicating a maximum number of users permitted to use said software program;
a step of said licensee of providing said expansion information to said user right administrative apparatus; and
a step of said user right administrative apparatus of revising, in response to a reception of said expansion information, said user right information stored therein.

2. The method as claimed in claim 1, wherein said predetermined event is that a number indicative of how many times said licensee is not allowed to activate said software program in a predetermined time period because no user right remains unused exceeds a predetermined number.

3. The method as claimed in claim 1, wherein said predetermined event is a reception of an alarm indicating that a natural disaster has occurred.

4. The method as claimed in claim 1, wherein said step of revising said user right information further comprises:
a step of receiving an expansion code from said licensee;
a step of decoding said expansion code to reproduce said expansion information; and
a step of revising said user right information using said expansion information.

5. The method as claimed in claim 1, wherein
said user rights are identified by respective identifying information;
said user rights information indicates which one of said user rights is in an effective state;
said expansion information indicates which one of said user rights is to be turned from an ineffective state to an effective state; and
the user right that is in the ineffective state cannot activate said software program.

6. The method as claimed in claim 1, wherein said user right administrative apparatus informs, instead of said licensee, an agreement administrative apparatus that issues said expansion information, of the occurrence of said predetermined event.

7. The method as claimed in claim 6, wherein said expansion information is provided by an agreement administrative apparatus instead of said licensee.

8. The method as claimed in claim 6, wherein
said agreement administrative apparatus retrieves, in response to a reception of the information of the occurrence of said predetermined event, agreement information indicating said maximum number corresponding to said software program and said licensee; and
said agreement administrative apparatus generates said expansion information.

9. The method as claimed in claim 5, wherein
said agreement administrative apparatus retrieves, in response to a reception of the information of the occurrence of said predetermined event, agreement information indicating which one of said user rights is in an effective state; and
said agreement administrative apparatus generates said expansion information indicating which one of said user rights is to be turned from said ineffective state to said effective state.

10. An administrative system of user rights of a software program that can be increased in number, comprising:
a communications unit;
a secondary storage unit; and
a central processing unit that determines whether a predetermined event has occurred, informs a licensee of the occurrence of said predetermined event, and revises, in response to a reception of an expansion information, user right information stored therein,
wherein
said licensee acquires said expansion information that causes said user right administrative apparatus to revise said user right information indicating a maximum number of users permitted to use said software program; and
said licensee provides said expansion information to said user right administrative apparatus.

11. The administrative system as claimed in claim 10, wherein
said user rights are identified by respective identifying information;
said user right information indicates which one of said user rights is in an effective state;
said expansion information indicates which one of said user rights is to be turned from an ineffective state to said effective state; and
the user right that is in the ineffective state cannot activate said software program.

12. An administrative system of agreement information of a software program in which user rights can be increased in number, comprising:
a communications unit;
an secondary storage unit; and
a central processing unit that retrieves, in response to a reception of information of an occurrence of a predetermined event, agreement information indicating a maximum number corresponding to said software program and a licensee, and generates an expansion information that causes an administrative apparatus of user rights.

13. A computer readable recording medium storing a computer program that administers user rights of a software program that can be increased in number, wherein said computer program causes a computer to:
determine whether a predetermined event has occurred;
inform a licensee of an occurrence of a predetermined event; and
revise, in response to a reception of expansion information, user right information stored therein;
wherein
said licensee acquires said expansion information that causes to revise said user right information indicating a maximum number of users permitted to use said software program; and
said licensee provides said expansion information to said computer.

14. The computer readable recording medium as claimed in claim 13, wherein
said user rights are identified by respective identifying information;
said user rights information indicates which one of said user rights is in an effective state;
said expansion information indicates which one of said user rights is to be turned from an ineffective state to an effective state; and
the user right that is in the ineffective state cannot activate said software program.
